(19) United States
(12) Patent Application Publication
(10) Pub. No.: US 2026/0105310 A1
(43) Pub. Date: Apr. 16, 2026

(54) TEXT-BASED LAST LAYER RETRAINING METHOD AND APPARATUS FOR DEBIASING IMAGE CLASSIFIER

(71) Applicant: SEOUL NATIONAL UNIVERSITY R&DB FOUNDATION, Seoul (KR)

(72) Inventors: Juhyeon PARK, Seoul (KR); Seokhyeon JEONG, Seoul (KR); Taesup MOON, Seoul (KR)

(21) Appl. No.: 18/945,086

(22) Filed: Nov. 12, 2024

(30) Foreign Application Priority Data
Oct. 10, 2024 (KR) 10-2024-0137811

(51) Int. Cl. G06N 3/0895; G06N 3/0455

(52) U.S. Cl. CPC G06N 3/0895; G06N 3/0455

(57) ABSTRACT

Proposed herein are a method and apparatus for retraining the last layer of a learning model. A method of retraining the last layer of a learning model that is performed by an apparatus for retraining the last layer of a learning model includes: training the last layer of a first learning model by inputting training text to a second learning model based on a projector that connects the first embedding space of the first learning model and the second embedding space of the second learning model.

### CROSS-REFERENCE TO RELATED APPLICATION

This application claims the benefit of Korean Patent Application No. 10-2024-0137811 filed on Oct. 10, 2024, which is hereby incorporated by reference herein in its entirety.

### BACKGROUND

### 1. Technical Field

The embodiments disclosed herein relate to a method and apparatus for retraining the last layer of a learning model, and more particularly, to a method and apparatus for training a last layer based on text to debias an image classifier.

The embodiments disclosed herein were derived as a result of the research on the task “Artificial Intelligence Graduate School Program (Seoul National University)” (task management number: IITP-II211343) of the Information, Communications and Broadcasting Innovative Talent Nurturing Project that was sponsored by the Korean Ministry of Science and ICT and the Institute of Information & Communications Technology Planning & Evaluation.

The embodiments disclosed herein were derived as a result of the research on the task “Research on Novel Continual Learning Algorithms with Practical Constraints on Data and Environments” (task management number: NRF-2021R1A2C2007884) of the Individual Basic Research Project that was sponsored by the Korean Ministry of Science and ICT and the National Research Foundation of Korea.

The embodiments disclosed herein were derived as a result of the research on the task “(Part 2) Few-Shot Learning of Causal Inference in Vision and Language for Decision Making” (task management number: IITP-II220959) of the Human-centered Artificial Intelligence Core Fundamental Technology Development Project that was sponsored by the Korean Ministry of Science and ICT and the Institute of Information & Communications Technology Planning & Evaluation.

### 2. Description of the Related Art

A training dataset used for training an image classifier includes spurious attributes that are not directly related to the labels to be predicted but have strong correlations. The problem in which the image classifier makes an incorrect prediction by relying on these spurious attributes may occur. This is the bias problem of image classifiers attributable to spurious attributes.

A representative debiasing algorithm for solving the bias problem of image classifiers is a method that retrains only the last layer of a trained image classifier based on a balanced data group set (see Non-patent Document 1). In this case, a data group may be defined based on a class set to be predicted and a spurious attribute set. The method according to Non-patent Document 1 is effective in debiasing, but has two problems. First, all data group information for individual images need to be labeled, so that the annotation costs are high. Second, it is difficult to secure images pertaining to a minority group to build a group-balanced dataset having a sufficient size. These problems make it difficult to apply the method according to Non-patent Document 1 to real situations.

Another algorithm intended to overcome the bias problem of image classifiers is a method that retrains only the last layer of an image classifier through contrastive learning based on an image-text set (see Non-patent Document 2). The method according to Non-patent Document 2 has a limitation in that it can only be applied to the embedding space obtained through contrastive learning based on an image-text set.

Therefore, there is a demand for a practical method that effectively mitigates the bias problem of learning models such as image classifiers.

### Related Art Literature

Non-patent Document 1: Polina Kirichenko et al., (DFR) Last Layer Re-Training is Sufficient for Robustness to Spurious Correlations, 30 Jun. 2023 (https://arxiv.org/pdf/2204.02937)
Non-patent Document 2: Yuhui Zhang et al., (DrML) Diagnosing and Rectifying Vision Models using Language, 8 Feb. 2023 (https://arxiv.org/pdf/2302.04269)
Non-patent Document 3: Alec Radford et al., (CLIP) Learning Transferable Visual Models From Natural Language Supervision, 26 Feb. 2021 (https://arxiv.org/pdf/2103.00020)

### SUMMARY

An object of the embodiments disclosed herein is to construct a dataset based on text data and retrain only a last layer by inputting text data using a projector connected to an image classifier having a feature extractor and the last layer, thereby debiasing the image classifier.

Other objects and advantages of the present invention may be understood from the following description, and will be more clearly understood from embodiments. In addition, it will be readily understood that the objects and advantages of the present invention may be realized by the means described in the attached claims and combinations thereof.

According to an aspect of the present invention, there is provided a method of retraining the last layer of a learning model, the method being performed by an apparatus for retraining the last layer of a learning model, the method including: training the last layer of a first learning model by inputting training text to a second learning model based on a projector that connects the first embedding space of the first learning model and the second embedding space of the second learning model.

According to another aspect of the present invention, there is provided an apparatus for retraining the last layer of a learning model, the apparatus including: memory configured to store a first learning model and a second learning model; and a controller configured to train the last layer of the first learning model by inputting training text to the second learning model based on a projector that connects the first embedding space of the first learning model and the second embedding space of the second learning model.

According to another aspect of the present invention, there is provided a non-transitory computer-readable storage medium having stored thereon a program that, when executed by a processor, causes the processor to execute the method of retraining the last layer of a learning model.

According to still another aspect of the present invention, there is provided a computer program that is executed by an apparatus for retraining the last layer of a learning model and stored in a non-transitory computer-readable storage medium to perform the method of retraining the last layer of a learning model.

According to any one of the above-described solutions, there are proposed the method and apparatus for training the last layer of a learning model that construct a text-based dataset and retrain only the last layer of an image classifier based on the text-based dataset, so that text can be utilized as a substitute for images, the annotation costs of data group information where a class set and a spurious attribute set are matched can be reduced, it is not necessary to collect additional image group-balanced datasets, and the bias of an image classifier can be mitigated.

Furthermore, according to any one of the above-described solutions, there are proposed the method and apparatus for training the last layer of a learning model that generate a projector that connects the first embedding space of a first learning model and the second embedding space of a second learning model, train the projector, and input training text data to the second learning model connected to the projector connected to the first learning model, so that universality can be improved to enable application to various learning models to mitigate bias without being limited to a specific learning model.

The advantages that can be achieved by the embodiments disclosed herein are not limited to the advantages described above, and other advantages not described above will be clearly understood by those having ordinary skill in the art, to which the embodiments disclosed herein pertain, from the foregoing description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating the functional configuration of a first learning model that classifies images;

FIG. 2 is a diagram illustrating an operation of training the last layer of the first learning model according to a conventional algorithm;

FIG. 3 is a block diagram illustrating the functional configuration of an apparatus for retraining the last layer of a learning model according to one embodiment;

FIG. 4 is a diagram illustrating the functional configuration of a second learning model configured to process an image-text set;

FIG. 5 is a diagram illustrating an operation in which an apparatus for retraining the last layer of a learning model according to one embodiment of the present invention retrains the last layer of the first learning model by using training text and a projector;

FIG. 6 is a diagram illustrating an operation in which the apparatus for retraining the last layer of a learning model according to the one embodiment trains a projector,

FIG. 7 is a diagram illustrating an operation in which the apparatus for retraining the last layer of a learning model according to the one embodiment generates a training text set;

FIG. 8 is a diagram illustrating an operation in which the apparatus for retraining the last layer of a learning model according to the one embodiment of the present invention trains the last layer of the first learning model;

FIG. 9 is a flowchart illustrating a method of retraining the last layer of a learning model according to one embodiment; and

FIG. 10 is a graph illustrating the model performances simulated according to embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

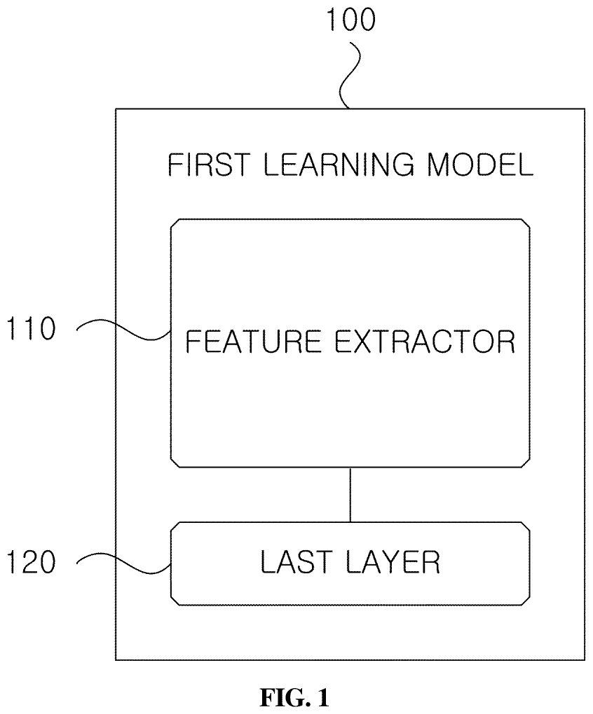

FIG. 1 is a diagram illustrating the functional configuration of a first learning model 100 that classifies images.

A “learning model” is a model that can be trained to process input data and predict results according to the purpose of a task, and may include a neural network where a plurality of layers are connected.

“Supervised learning” is a method of training a model using input data that is labeled with a label indicating a correct answer for the data.

The term “label” refers to each class assigned to data, and the term “class” refers to the group to which data belongs in a dataset. The term “correct label” refers to an actual label treated as a correct answer, and the term “predicted label” refers to a label inferred by a model.

The “first learning model 100” is a learning model that operates as an image classifier that receives images as input and classifies the images.

The “image classifier” is a neural network that can detect features from input images and classify the input images based on the features. Various types of deep learning networks may be applied depending on the need. For example, among various deep learning networks, a convolutional neural network (CNN) may be used to process image or video data, and other neural networks may also be applied.

The “neural network” is formed in a network structure where a plurality of layers are connected, and each of the layers includes a node as a constituent unit. A learning model may have parameters that are learning targets, and the parameters may include weights and biases.

The “weight” is a parameter that controls the influence of input on output at the node of a layer, and the “bias” is a parameter that controls how easily the node of a layer is activated (output as 1).

An “activation function” is a function that converts linear values, considering weights and biases in input, into nonlinear values and outputs them. A layer that outputs linear values without applying an activation function is also possible.

The first learning model 100 may include a feature extractor 110 and a last layer 120.

The feature extractor 110 processes input data through the layers of the learning model and outputs features, which are core information appropriately represented to perform a specific task. In this case, the features include information that represents a target desirably to fit the specific task, and may be represented in a vector form that can be recognized by a computer or the like.

“Embedding” is converting data using a vector space so that a learning model can understand the relationship of data, and an “embedding vector” is information represented by a vector through embedding. For example, embedding may be understood as a form of dimension reduction or data compression. “Embedding space” is a distribution space of features that represent a target desirably, and may be represented as a vector space that represents the relationship between classes. The embedding space is also called latent space, and each class is mapped to a specific location in this space.

The last layer 120 is a classification layer that outputs predicted classification results as probability values. The classification layer is mainly connected at the end of a learning model. In the present specification, the layer that performs a classification function is described as the last layer, but another layer may be connected to the end of the layer that performs the classification function when necessary. In other words, depending on the configuration of a learning model, the location of a classification layer that is subject to retraining may not be the last, but will be referred to as the “last layer” for convenience of description.

In order to overcome the problem of bias in which an image classifier outputs incorrect prediction results by relying on spurious attributes of training data in an image classification process, it is necessary to define data groups. The data distribution may be specified by a data group [symbol] defined by the Cartesian product of a set of labels [symbol] and a set of spurious attributes [symbol] . That is, [symbol] :32 [symbol] × [symbol] . For example, in the Waterbirds dataset, the label of a class indicates whether a bird in an image is a landbird or waterbird, and the spurious attribute is the background of the image. Accordingly, the group may be specified as [symbol] ={landbirds, waterbirds}×{land backgrounds, water backgrounds}. Due to the prevalence of waterbirds with water backgrounds as well as landbirds with land backgrounds, the minority groups are (landbirds, water backgrounds) and (waterbirds, land backgrounds). The reliance of the image classifier on the spurious features may be typically evaluated by the Worst Group Accuracy (WGA).

In the process of classifying classes for the Waterbirds dataset, the image classifier may infer landbirds as waterbirds based on the water background or waterbirds as landbirds based on the land background. In order to mitigate the problem of spurious correlation, an algorithm that retrains only the last linear classification layer of the image classifier has emerged.

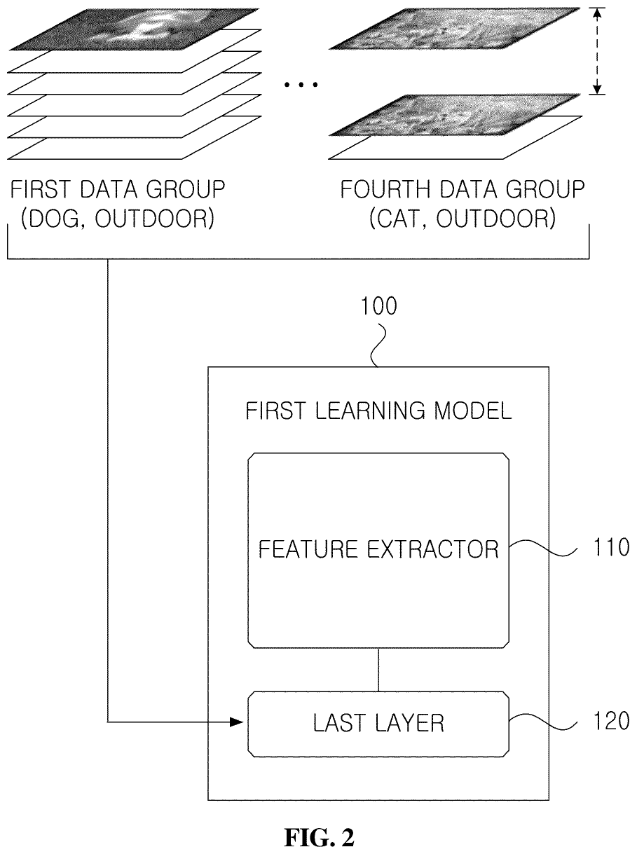

FIG. 2 is a diagram illustrating an operation of training the last layer of the first learning model according to a conventional algorithm.

The conventional algorithms that retrain only the last layer 120 out of the feature extractor 110 and the last layer 120 included in the first learning model 100 are effective in mitigating bias, but they have many disadvantages. Among the conventional algorithms, the technology disclosed in Non-patent Document 1 requires the labeling of all the data group information of each image during a learning process, which incurs a lot of annotation costs. In particular, it is difficult to collect images pertaining to a minority group. In addition, the technology disclosed in Non-patent Document 2 has a limitation in that it can only be applied to the embedding space obtained by contrastive learning based on an image-text set.

In order to mitigate the difficulty of labeling training data and collecting images and improve the universality applicable to various learning models, the apparatus for training the last layer of a learning model according to the present embodiment overcomes the problems through the following core technical means.

First, a projector that connects the joint embedding space according to the image-text contrastive learning and the embedding space of the image classifier is trained. The present embodiment overcomes the limitation of being applied only to the embedding space limited to a specific learning model by generating and learning the projector, and may be applied to a general image classifier structure.

Second, text is generated using a large language model, and the text is filtered based on cosine similarity and the predicted value of the image classifier. The present embodiment may build a dataset at the costs lower than the costs of collecting images and labeling individual images by using text data as input data. In particular, the accuracy of the learning model may be improved when the classification layer is retrained.

Third, the classification layer of the image classifier is retrained based on the projector and the text dataset. The present embodiment may effectively overcome the bias problem of the image classifier by utilizing the projector and the text dataset.

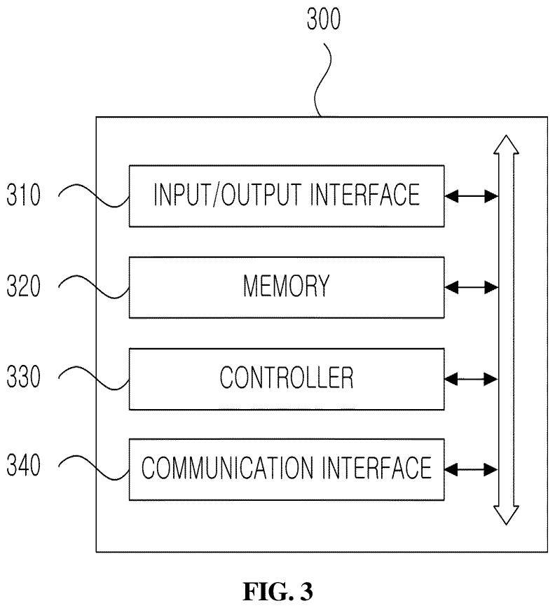

FIG. 3 is a block diagram illustrating the functional configuration of an apparatus 300 for retraining the last layer of a learning model according to one embodiment.

Referring to FIG. 3, the apparatus 300 for retraining the last layer of a learning model according to an embodiment may include an input/output interface 310, memory 320, a controller 330, and a communication interface 340.

The input/output interface 310 may include an input interface configured to receive input from a user, and an output interface configured to display information such as the results of performing a task or the status of the apparatus 300 for retraining the last layer of a learning model. That is, the input/output interface 310 is configured to receive data and output the results of computing the data. The apparatus 300 for retraining the last layer of a learning model according to the one embodiment may receive a last layer retraining request and the like through the input/output interface 310.

The memory 320 is configured to store files and programs, and may be constructed through various types of memory. In particular, the memory 320 may store data and programs that enable the controller 330, to be described below, to perform computation for layer retraining according to the algorithm to be presented below.

The memory 320 may store a first learning model configured to process images and a second learning model configured to process an image-text set. The memory 320 may store a projector configured to connect the first embedding space of the first learning model and the second embedding space of the second learning model. The memory 320 may also store a large language model and the text generated by the large language model.

The controller 330 is configured to include at least one processor, such as a central processing unit (CPU), a graphics processing unit (GPU), or the like, and may control the overall operation of the apparatus 300 for retraining the last layer of a learning model. That is, the controller 330 may control other components included in the apparatus 300 for retraining the last layer of a learning model to perform operations for layer retraining. The controller 330 may perform computation for extracting a representation according to the algorithm to be presented below by executing the program stored in the memory 320.

The communication interface 340 may perform wired/wireless communication with another device or a network. For example, when a server for providing a service of a specific online platform that collects or processes a training dataset is implemented as a separate device, the communication interface 340 may receive a training dataset through communication with the server for providing the service of the online platform, and may provide a learning model, retrained based on the received dataset, to the server or a user terminal.

To this end, the communication interface 340 may include a communication module configured to support at least one of various wired/wireless communication methods. The communication module may be implemented in the form of a chipset. The mobile or wireless communication supported by the communication interface 340 may be, for example, an N-generation mobile communication protocol, Wireless Fidelity (Wi-Fi), Wi-Fi Direct, Bluetooth, Ultra-Wide Band (UWB), or Near Field Communication (NFC).

The controller 330 trains a layer of a specific learning model using a projector that connects a plurality of learning models. The controller 330 may train the last layer (e.g., the classification layer) of the first learning model by inputting training text to the second learning model based on the projector that connects the first embedding space of the first learning model configured to process images and the second embedding space of the second learning model configured to process an image-text set.

The controller 330 may generate the projector that connects the first embedding space of the first learning model configured to process images and the second embedding space of the second learning model configured to process an image-text set before training the last layer of the first learning model.

The first learning model that is connected to the projector generated by the controller 330 may include a last layer that classifies images based on the first embedding space where the features extracted by a feature extractor from images are mapped.

The second learning model that is connected to the projector generated by the controller 330 may predict results based on the second embedding space where the features extracted by an image encoder from the image of the image-text set and the features extracted by a text encoder from the text of the image-text set are mapped.

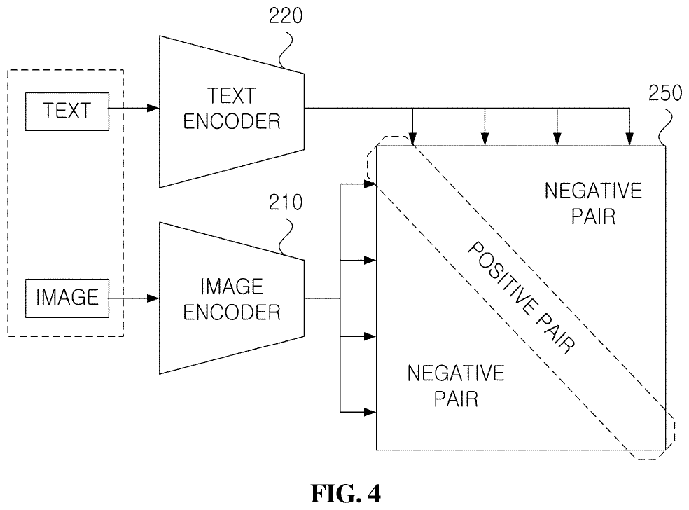

FIG. 4 is a diagram illustrating the functional configuration of a second learning model 200 configured to process an image-text set.

The second learning model 200 may include an image encoder 210 and a text encoder 220. The image encoder 210 may extract features from an input image and represent them by a single vector value, and the text encoder 220 may extract features from input text and represent them by a vector value.

The second learning model 200 may be a learning model to which self-supervised learning is applied. In this case, self-supervised learning performs learning without labeled data and optimizes the distances between features mapped in embedding space.

In particular, self-supervised learning utilizing contrastive learning may use positive samples as training data adapted to minimize the distance and also use negative samples for training. Positive sample data is data that has a class identical or similar to the class of a target data, and negative sample data is data that has a class that is not identical to or dissimilar to the class of a target data. The degree of identity or similarity may be measured based on various distances between values. The loss function of contrastive learning may be trained to minimize the distance between positive samples and maximize the distance between negative samples.

The second learning model 200 may map the embedding vector according to the features of the image and the embedding vector according to the features of the text together in the second embedding space 250 through contrastive learning. The second embedding space 250 may be called a “joint embedding space.”

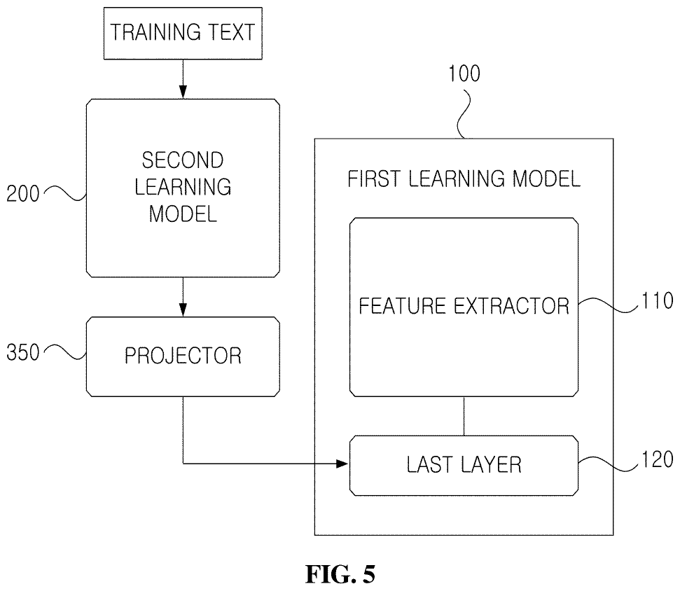

FIG. 5 is a diagram illustrating an operation in which an apparatus for retraining the last layer of a learning model according to one embodiment of the present invention retrains the last layer of the first learning model by using training text and a projector.

The controller 330 may train the last layer 120 of the first learning model 100 by inputting training text to the second learning model 200 based on the projector 350 that connects the first embedding space of the first learning model 100 configured to process images and the second embedding space of the second learning model 200 configured to process an image-text set.

In the process of generating the projector 350, the controller 330 may train the projector 350 to project the embedding vector of the second embedding space 250, to which the features extracted by the image encoder 210 of the second learning model 200 are mapped, onto the embedding vector of the first embedding space 150, to which the features extracted by the feature extractor 110 of the first learning model 100 are mapped, by using the data used for training the first learning model 100.

The controller 330 may train the projector 350 by considering the orthogonality between the weight of the projector 350 and the modality gap of the second embedding space 200 in the process of training the projector 350. In this case, the modality gap indicates the state of alignment between the embedding vector corresponding to the image of the image-text set and the embedding vector corresponding to the text of the image-text set in the second embedding space 250.

The controller 330 may train the projector 350 to satisfy the condition in which the modality gap lies in the nullspace of the transpose matrix of the weight of the projector 350 in the process of training the projector 350.

The controller 330 may select training text based on the first embedding space 150 of the first learning model 100 and the second embedding space 250 of the second learning model 200.

The controller 330 may generate first training text regarding the labels of classes and second training text regarding spurious attributes causing spurious correlations by using a language model in the process of selecting training text.

The control unit 330 may primarily filter the first training text based on the second embedding space 250. The control unit 330 may primarily filter the second training text based on the second embedding space 250.

The controller 330 may secondarily filter the primarily filtered first training text based on the last layer 120 according to the first embedding space 150 projected from the second embedding space 250 through the projector 350 in the process of selecting the training text.

In the process of training the last layer 120 of the first learning model 100, the controller 330 may project the average of a plurality of embedding vectors, mapped to the second embedding space 250 by using the secondarily filtered first training text and the primarily filtered second training text, onto the embedding vector of the first embedding space 150 through the projector 350, and may train the last layer by using the projected embedding vector.

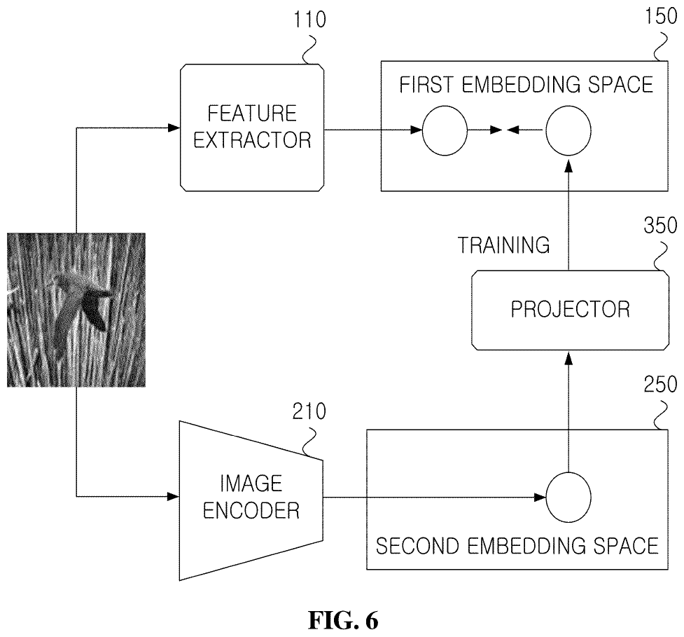

The main operations of the present embodiment will be described in more detail with reference to FIGS. 6 to 8 below.

FIG. 6 is a diagram illustrating an operation in which the apparatus 100 for retraining the last layer of a learning model according to one embodiment trains a projector.

Referring to FIG. 6, the apparatus 100 for retraining the last layer of a learning model according to the present embodiment trains the projector 350 that connects the second embedding space 250 according to image-text contrastive learning and the first embedding space 150 of the image classifier.

The apparatus 100 for retraining the last layer of a learning model selects the second learning model 200 that has completed contrastive learning based on an image-text set. In order to retrain the image classifier based on text, there may be used a model that has performed contrastive learning using a large-scale image-text paired dataset, such as the CLIP model described in Non-patent Document 3. Since the embedding space learned through contrastive learning may not be directly utilized for the retraining of the last layer of the image classifier, there is required a process of projecting the text embedding, present in the second embedding space 250 according to image-text contrastive learning, into the first embedding space 150 of the image classifier.

The feature extractor 110 and last linear classification layer 120 of the first learning model 100 are denoted by f_{θ} and h_{φ}, and corresponding parameters are denoted by θ and φ.

The two embedding spaces to be connected by the projector 350 are the joint embedding space generated by an image-text contrastive learning-based model (e.g., the CLIP model described in Non-patent Document 3) and the image embedding space generated by the second last layer of the general image classifier. A representation vector for each text embedding in the embedding space of the CLIP model is represented by

$${z}_{T}^{CLIP} ∈ {ℝ}^{{d}_{CLIP}} ,$$

and the image embedding obtained by f_{θ} is denoted by

$${z}_{I}^{{f}_{θ}} ∈ {ℝ}^{{d}_{{f}_{θ}}} .$$

d_{CLIP} and d_{f}_{_{θ}} represent the dimensions of the respective embedding spaces. The embedding space of the CLIP model is considered to be a representative joint embedding space, and may also be understood as another similar embedding space that processes an image-text set.

In the joint embedding space, there is a modality gap, which represents a constant gap between image and text embeddings. It may be possible to consider a modality gap for each instance.

When (I, T) represents an image-text set or an image-text pair, the modality gap g in the joint embedding space of the second learning model is defined as follows:

$$g := {z}_{I}^{CLIP} - {z}_{T}^{CLIP}$$

Although the above definition is intended for the embedding space of the CLIP model, g may be defined in any joint embedding space where two modalities are well aligned.

The presence of the modality gap enables to achieve cross-modal transferability, which enables using embeddings from different modalities interchangeably. That is, for an image-text pair (I, T),

$$h ( {z}_{I}^{CLIP} ) \approx h ( {z}_{T}^{CLIP} ) ,$$

in which h is a linear classifier in the embedding space of the CLIP model. However, the limitation of such cross-modal transferability is that it could be only achieved in the joint embedding space such as that of the CLIP model and not in other general embedding spaces (e.g., an embedding space obtained by a general feature extractor f_{θ}).

The apparatus 100 for retraining the last layer of a learning model aims to overcome the above limitation and enable the cross-modal transferability beyond the joint embedding space. To this end, a linear projector Π:

$${ℝ}^{{d}_{CLIP}} \to {ℝ}^{{d}_{{f}_{θ}}}$$

that projects

$${z}_{I}^{CLIP}$$

onto

$${z}_{I}^{{f}_{θ}}$$

is taken into consideration. That is, (W, b) is denoted as the linear matrix and bias vector that define the projector Π. Then, it is assumed that both

$${z}_{I}^{CLIP} and {z}_{I}^{{f}_{θ}}$$

reside in linearly separable spaces an there is present a linear projector Π that satisfies

$$Π ( {z}_{I}^{CLIP} ) \approx {z}_{I}^{{f}_{θ}} .$$

Now, for the cross-modal transferability in the embedding space of f_{θ},

$${h}_{ϕ} ( {z}_{I}^{{f}_{θ}} ) \approx {h}_{ϕ} ( Π ( {z}_{T}^{CLIP} ) )$$

is achieved for a pair (I, T). That is, the projected embedding of a CLIP text embedding is used interchangeably for the image embedding of f_{θ}. Then, a sufficient condition for the projector Π may be derived by examining Equations 1 to 3 below:

$${h}_{ϕ} ( Π ( {z}_{T}^{CLIP} ) ) = {h}_{ϕ} ( {W}^{T} {z}_{T}^{CLIP} + b ) \qquad ( 1 )$$

$${h}_{ϕ} ( Π ( {z}_{T}^{CLIP} ) ) = {h}_{ϕ} ( {W}^{T} ( {z}_{I}^{CLIP} - g ) + b ) \qquad ( 2 )$$

$${h}_{ϕ} ( Π ( {z}_{T}^{CLIP} ) ) = {h}_{ϕ} ( Π ( {z}_{I}^{CLIP} ) - {W}^{T} g ) \approx {h}_{ϕ} ( {z}_{I}^{{f}_{θ}} - {W}^{T} g ) \qquad ( 3 )$$

Equation 2 follows the definition of the modality gap, and Equation 3 follows the assumption and the continuity of h_{φ}. Accordingly, from Equations 1 to 3, it may be easily deduced that the sufficient condition for the cross-modal transferability is W^{T}g=0; i.e., the modality gap g should lie in the nullspace of W^{T}. Based on this sufficient condition, the linear projector Π may be obtained.

The apparatus 100 for retraining the last layer of a learning model estimates the modality gap in order to compute the optimal parameters of the projector Π that connects the second embedding space 250 and the first embedding space 150. To estimate the modality gap, the average of the embedding differences in the contrastive learning embedding space is computed based on the image-text set. Then, the weights and bias (W, b) of the projector 350 are computed using the modality gap.

The apparatus 100 for retraining the last layer of a learning model trains a projector with the characteristics of the embedding space of the contrastive learning considered by utilizing the data used for the training of the image classifier. This method effectively reflects the data distribution considered by the image classifier, does not require a learning process based on gradient descent, and may obtain the optimal parameters in a closed form.

To extend the cross-modal transferability in the embedding space of an arbitrary image classifier, the constraint W^{T}g=0 is imposed on the projector Π. The modality gap g is simply estimated by sampling image-text pairs from an image-text dataset and averaging their gaps. That is,

$$\hat{g} = \frac{1}{N} {\sum }_{i = 1}^{N} ( {z}_{{I}_{i}}^{CLIP} - {z}_{{T}_{i}}^{CLIP} ) .$$

The estimates of the modality gaps may be easily obtained from an open-sourced image-text paired dataset and the estimated gap is independent of the dataset used to train the image classifier f_{θ}. With the estimated gap, (W, b) of Π is obtained by solving the constrained ridge regression problem.

X∈ [symbol] ^{n×d}^{_{CLIP}} is the embedding matrix of n training images, and

$$Y ∈ {ℝ}^{n \times {d}_{{f}_{θ}}}$$

is an embedding matrix generated by the image classifier f_{θ} for the corresponding images.

$$W ∈ {ℝ}^{{d}_{CLIP} \times {d}_{{f}_{θ}}}$$

is the weight of the projector, and

$$b ∈ {ℝ}^{{d}_{{f}_{θ}}}$$

is the bias of the projector. g∈ [symbol] ^{d}^{_{CLIP}} is the modality gap.

The linear relationship between X and Y is represented by Equation 4 below:

$$Y \sim XW + b + ϵ , ϵ \sim 𝒩 ( 0 , \sum ) \qquad ( 4 )$$

Then, the ridge regression estimate of (W, b) with the constraint W^{T}g=0 is represented by Equations 5 and 6 below:

$${W}^{*} = \tilde{W} - {( {X}^{T} X + λ I )}^{- 1} {g ( {{g}^{T} ( {X}^{T} X + λ I )}^{- 1} g )}^{- 1} {g}^{T} \tilde{W} \qquad ( 5 )$$

$${b}^{*} = \frac{1}{n} {( Y - {XW}^{*} )}^{T} 𝕝 \qquad ( 6 )$$

It is assumed that \tilde{W}=(X^{T}X+λI)⁻¹X^{T}Y and Σ is diagonal. λ is a hyperparameter for the [symbol] ₂ regularization and searched based on the Normalized Mean Square Error (NMSE) criterion. NMSE evaluates the normalized [symbol] ₂ distance between original embedding and predicted embedding.

The present embodiment has a clear advantage in that it does not require gradient descent-based optimization for the training of the projector Π and additional tedious search for hyperparameters (e.g., training rate, weight decay, etc.).

According to the present embodiment, the same image is input to the feature extractor 110 f_{θ} of the first learning model and the image encoder 210 of the second learning model, and (W*, b*) of the projector Π minimizes the distance between the embedding of f_{θ} and the projected embedding.

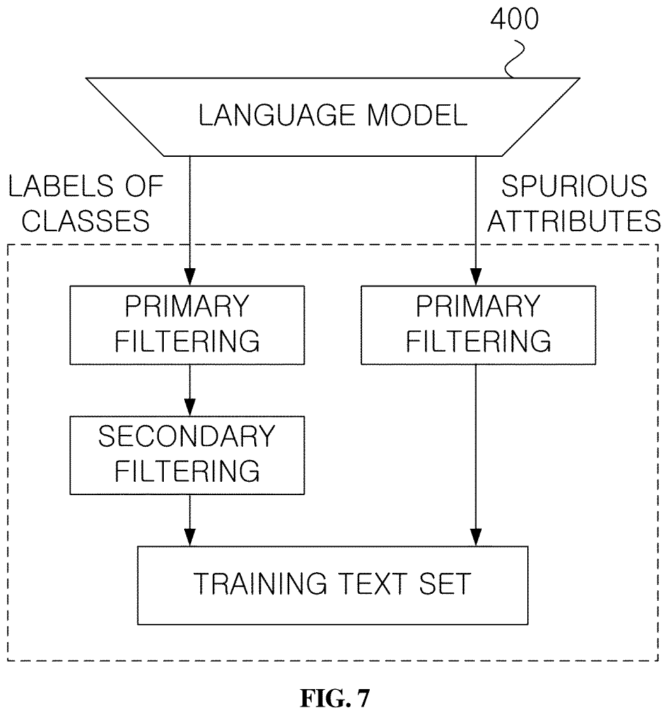

FIG. 7 is a diagram illustrating an operation in which the apparatus 100 for retraining the last layer of a learning model according to the one embodiment generates a training text set.

The apparatus 100 for retraining the last layer of a learning model generates required words by utilizing the language model 400 to retrain the last layer of the image classifier.

The apparatus 100 for retraining the last layer of a learning model generates synonyms for the categories of classes and spurious attributes by using a large language model (LLM). That is, synonyms for the names of categories pertaining to the set (Y, A) are generated through the LLM.

Given the class labels for Y and A and the category names of spurious attributes, various words corresponding to the names are generated by generating synonyms.

The word set generated for the y-th element of Y is denoted by [symbol] ^{y}, the i-th generated word is denoted by

$${t}_{i}^{y} ∈ {𝒯}^{y} , and {t}_{i}^{a} ∈ {𝒯}^{a}$$

is defined for A in the same manner.

The generated text and the projected embedding for the text may be out-of-distribution (OOD) examples for the second learning model and the feature extractor, which may reduce the performance of layer training. Since the generated words include incorrect words due to the hallucination problem of the language model, it is necessary to filter out incorrect words based on two metrics.

The first metric is the cosine similarity of the text embedding in contrastive learning latent space, and words are each adopted only when the similarity between a generated word and a word in a corresponding category is higher than the similarities with other categories. This allows the selection of accurate words.

The second metric is performed to project each generated word into the embedding space of the image classifier by using the projector, obtains a predicted value through the trained last classification layer, and adopts the word only when the predicted value is a category that matches the generated word. Through this, words that can be understood by the image classifier well may be selected.

Accordingly, it is necessary to maintain only words that are compatible with the embedding space of the second learning model and the feature extractor by implementing validation of embedding alignment (VEA) for generated words.

The apparatus 100 for retraining the last layer of a learning model inspects whether the words generated through the LLM are well aligned with the embedding spaces of the first learning model and the second learning model. The apparatus 100 for retraining the last layer of a learning model primarily filters the generated words based on the cosine similarity with the names of the categories in the embedding space. Then, secondary filtering is performed based on the predicted value of the image classifier, which is the first learning model.

More specifically, for Y={y₁, y₂}, there is performed a process in which the word t generated as a synonym of y₁ is adopted only when cos (y₁, t)>cos(y₂, t) is satisfied, and the same process is performed for A.

For the words generated as synonyms of the category names of the set Y, additional filtering is performed based on the predicted values of the trained image classifier.

More specifically, for the word t generated as a synonym of y₁, it is projected into the embedding space of the image classifier, and then there is performed the process of adopting it only when the predicted value obtained by putting it into an existing trained last classification layer is y₁.

In the case of VEA for the second learning model, the embedding of the words generated from [symbol] ^{y} for each y∈Y is expected to be close to

$${z}_{y}^{CLIP} ,$$

words that are not aligned with the second embedding space of the second learning model may be removed using a simple and effective rule.

The apparatus 100 for retraining the last layer of a learning model selects only tᵢ^{y} having the largest cosine similarity with the corresponding class y in the text embedding space of the second learning model according to Equation 7 below:

$$arg {max}_{{y}^{′} ∈ 𝒴} cosine - similarity ( {z}_{{P}_{1} ( {t}_{i}^{y} )}^{CLIP} , {z}_{{P}_{1} ( {y}^{′} )}^{CLIP} ) = y \qquad ( 7 )$$

For example, P₁ is a prompt template with P₁(t)=“A photo of a {t}”.

The VEA of the generated words for Ja is also performed similarly.

In the case of VEA for the feature extractor, when the VEA for the second learning model is completed, the filtered words are semantically well aligned with the embedding space of the second learning model.

However, for the filtered word of Ty, the embedding of the projected second learning model may be an out-of-distribution (OOD) example within the embedding space of the feature extractor f_{θ}, so that it may still not be well aligned with the embedding space of f_{θ}.

This alignment error may cause additional confusion when new classification boundaries are constructed through layer training. To overcome this problem, a logit-based VEA for the feature extractor f_{θ} is implemented to additionally remove misaligned words in [symbol] ^{y}. The logit represents a predicted value that is not normalized to a probability range.

The apparatus 100 for retraining the last layer of a learning model selects only t′ that satisfies Equation 8 for VEA for the feature extractor.

$$arg {max}_{{y}^{′} ∈ 𝒴} {h}_{ϕ} {( Π ( {z}_{{P}_{1} ( {t}_{i}^{y} )}^{CLIP} ) )}_{{y}^{′}} = y \qquad ( 8 )$$

In Equation 8, Π is the projector defined by (W*, b*), and h_{φ}(⋅)_{y′} denotes the y′-th element of h_{φ}(⋅). This logit-based VEA is performed only for the words in [symbol] ^{y}.

The apparatus 100 for retraining the last layer of a learning model constructs a dataset of word pairs based on the remaining words after the VEA. All possible combinations may be considered for each data group. That is, [symbol] ^{y}× [symbol] ^{a} is for group (y, a), where [symbol] ^{y} and [symbol] ^{y} now include only validated words.

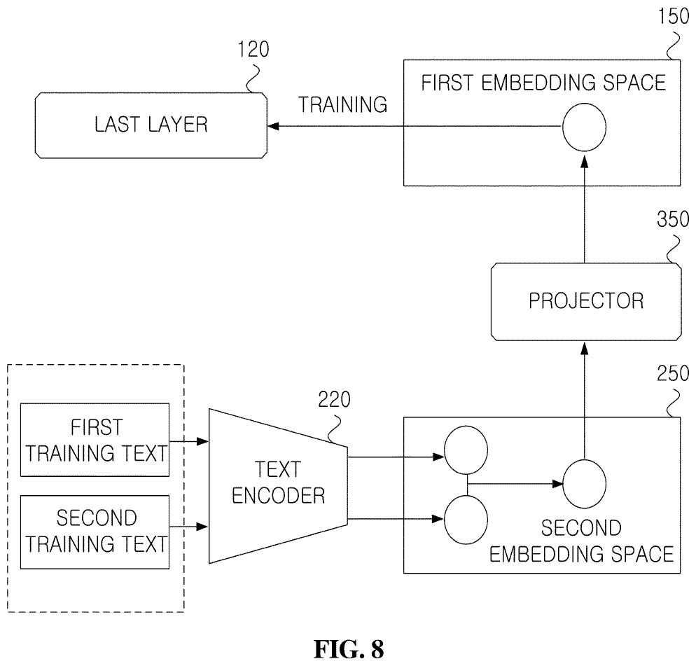

FIG. 8 is a diagram illustrating an operation in which an apparatus for retraining the last layer of a learning model according to one embodiment of the present invention trains the last layer of a first learning model.

The apparatus 100 for retraining the last layer of a learning model performs the embedding of first training text for each class and second training text for spurious attributes by using the text encoder 220 of the second learning model.

The apparatus 100 for retraining the last layer of a learning model averages text embeddings for each class and spurious attributes in the second embedding space 250, and projects them to the first embedding space 150 of f_{θ} through the projector 350. The projected embeddings are fed to h_{φ} and used for retraining. The apparatus 100 for retraining the last layer of a learning model retrains the last classification layer of the image classifier by using the projector 350 and the text dataset. The apparatus 100 for retraining the last layer of a learning model performs text-based layer training by using the projected embeddings of the text prompts obtained from the verified words.

The apparatus 100 for retraining the last layer of a learning model constructs a text dataset based on filtered words. In this case, the data pertaining to each group is composed of the average of the text embeddings of the synonyms of y and a. More specifically, the data pertaining to a group (y₁, a₁) is the average embedding of the text embeddings of the synonyms of y₁ and a₁.

After a text-based dataset has been constructed in this manner, each text embedding is projected into the first embedding space 150 of the image classifier based on the projector 350. Then, the last layer is retrained. When the last classification layer is retrained, training may be performed by sampling a group-balanced text dataset for each epoch.

The apparatus 100 for retraining the last layer of a learning model computes the text embedding of the second learning model using word pairs, and projects it into the embedding space of f_{θ} by using (W*, b*) of the projection model. When the text embedding of the second learning model is computed for the samples of the data group (y, a),

$${t}_{i}^{y} and {t}_{j}^{a}$$

are not simply concatenated by using a single text prompt. Instead, the average of the two text embeddings computed for

$${t}_{i}^{y} and {t}_{j}^{a} ,$$

respectively, is computed. That is,

$$\frac{1}{2} ( {z}_{{P}_{1} ( {t}_{i}^{y} )}^{CLIP} , {z}_{{P}_{1} ( {t}_{j}^{a} )}^{CLIP} )$$

is computed as the embedding for (y, a). The reason for this is the method using

$$\frac{1}{2} ( {z}_{{P}_{1} ( {t}_{i}^{y} )}^{CLIP} , {z}_{{P}_{1} ( {t}_{j}^{a} )}^{CLIP} )$$

better reflects that individual embeddings of

$${t}_{i}^{y} and {t}_{j}^{a}$$

than the method of concatenating

$${t}_{i}^{y} and {t}_{j}^{a} .$$

Furthermore, to represent the more diverse nature of images having texts, a plurality of prompt templates used in zero-shot classification may be employed. When each

$$( {t}_{i}^{y} , {t}_{j}^{a} )$$

pair is fetched

$$\frac{1}{2} ( {z}_{{P}_{1} ( {t}_{i}^{y} )}^{CLIP} , {z}_{{P}_{1} ( {t}_{j}^{a} )}^{CLIP} )$$

is computed, in which case Pₖ(⋅) is randomly selected from the plurality of prompt templates. Other prompts or prompt tuning may also be used to effectively capture more diverse styles, domains, and other facets.

The retraining of the last layer may be performed by mini-batch optimization. Furthermore, model ensemble may be avoided to reduce training costs, and group-balanced training sets may be sampled every epoch to maximally utilize available data. By default, there is adopted early stopping based on validation WGA.

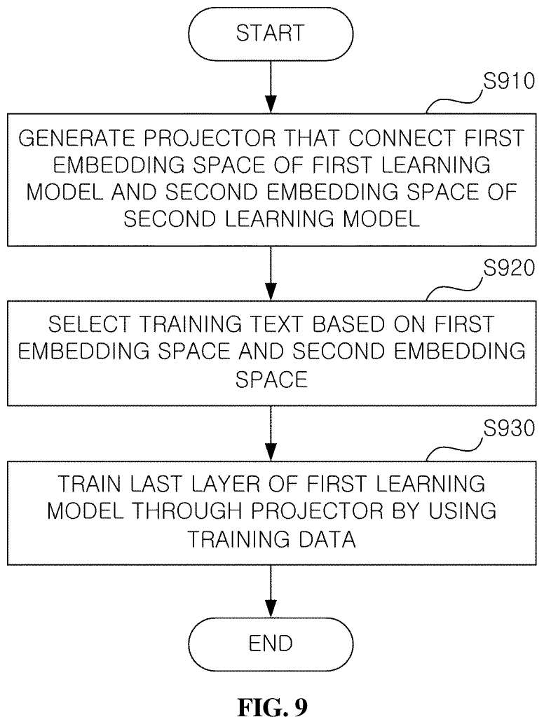

FIG. 9 is a flowchart illustrating a method of retraining the last layer of a learning model according to one embodiment.

The method of retraining the last layer of a learning model shown in FIG. 9 includes the steps that are processed in a time-series manner by the apparatus for retraining the last layer of a learning model shown in FIGS. 1 to 8. Accordingly, the descriptions that are omitted below but have been given above in conjunction with the apparatus for retraining the last layer of a learning model shown in FIGS. 1 to 8 may also be applied to the method of retraining the last layer of a learning model shown in FIG. 9.

Referring to FIG. 9, in step S930, the apparatus for retraining the last layer of a learning model trains the last layer of a first learning model by inputting training text to a second learning model based on a projector that connects the first embedding space of the first learning model and the second embedding space of the second learning model.

Before step S930 of training the last layer of a first learning model, the apparatus for retraining the last layer of a learning model may perform step S910 of generating a projector that connects the first embedding space of the first learning model configured to process images and the second embedding space of the second learning model configured to process an image-text set.

Before step S930 of training the last layer of a first learning model, the apparatus for retraining the last layer of a learning model may perform the step S920 of selecting training text based on the first embedding space of the first learning model and the second embedding space of the second learning model.

The first learning model applied to the method of retraining the last layer of a learning model may include a last layer that classifies images based on the first embedding space where the features extracted by the feature extractor from the images are mapped.

The second learning model applied to the method of retraining the last layer of a learning model may predict results based on the second embedding space where the features extracted by the image encoder from the image of the image-text set and the features extracted by the text encoder from the text of the image-text set are mapped.

Step S910 of generating a projector may include the step of training a projector that projects the embedding vector of the second embedding space, where the features extracted by the image encoder of the second learning model are mapped, onto the embedding vector of the second embedding space, where the features extracted by the feature extractor of the first learning model are mapped, by using the data used for training the first learning model.

The step of training a projector may include the step of training the projector by considering the orthogonality between the weight of the projector and the modality gap of the second embedding space. In this case, the modality gap may indicate the state of alignment between the embedding vector corresponding to the image of the image-text set and the embedding vector corresponding to the text of the image-text set in the second embedding space.

The step of training a projector may include the step of training the projector to satisfy the condition in which the modality gap lies in the nullspace of the transpose matrix of the weight of the projector.

Step S920 of selecting training text may include the step of generating first training text regarding the labels of classes and second training text regarding spurious attributes causing spurious correlations by using a language model.

Step S920 of selecting training text may include the step of primarily filtering first training text based on the second embedding space. Step S920 of selecting training text may include the step of primarily filtering second training text based on the second embedding space.

Step S920 of selecting training text may include the step of secondarily filtering the primarily filtered first training text based on the last layer according to the first embedding space projected from the second embedding space through the projector.

Step S930 of training the last layer of a first learning model may include the step of projecting the average of a plurality of embedding vectors, mapped to the second embedding space by using the secondarily filtered first training text and the primarily filtered second training text, onto the embedding vector of the first embedding space through the projector and training the last layer by using the projected embedding vector.

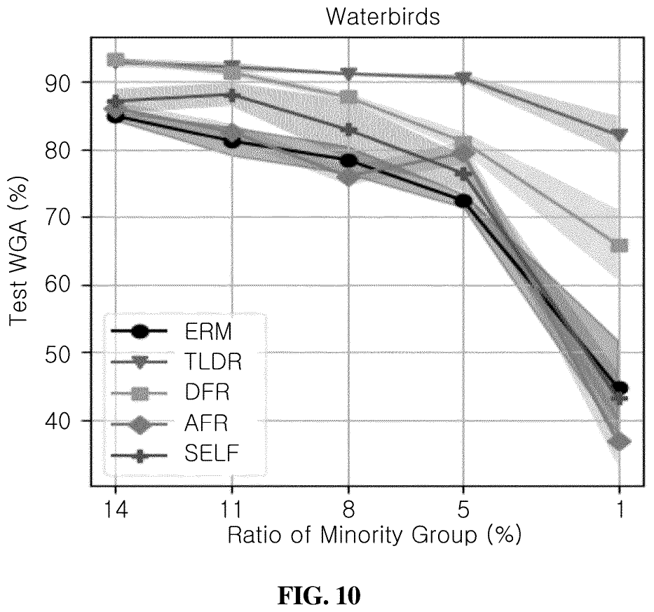

FIG. 10 is a graph illustrating the model performances simulated according to embodiments.

The present embodiment retrains only the last layer of an image classifier by inputting text data using a projector. The present embodiment may be called Text-based Last-layer retraining for Debiasing image classifieRs (TLDR).

Comparative examples are Empirical Risk Minimization (ERM), Deep Feature Reweighting (DFR), Automatic Feature Reweighting (AFR), and SElective Last-layer Finetuning (SELF). ERM is a method that minimizes the risk of limited training data sampled from the population. DFR is an algorithm according to Non-patent Document 1, and retrains only the last layer of an image classifier by inputting a balanced data group. AFR integrates the last layer retraining and the inference of the data group information and retrains the last layer of the ERM model having a weighted loss function that assigns higher importance to instances having poorer predictions. SELF infers the data pertaining to a minority group from a holdout dataset consisting of half of a validation set by utilizing checkpoints, and additionally trains the overall model.

It can be seen that TLDR according to the present embodiment has better WGA evaluation performance for minority groups than comparative examples ERM, DFR, AFR, and SELF.

The low performance of DFR and SELF is due to the limited data for each group in the balanced data group set. The small number of groups affects retraining and WGA validation evaluation. The reason for this is that DFR and SELF randomly divide the validation set in half for WGA evaluation, which leads to suboptimal hyperparameter search. In contrast, TLDR avoids this problem by neither splitting the validation set nor using it for last layer retraining.

TLDR according to the present embodiment is efficient and practical because it can be applied to a pre-trained model without the additional training of the overall model.

TLDR according to the present embodiment exhibits robust performance in various minority ratios, so that it can be utilized even in situations where images pertaining to minority groups are insufficient.

In connection with the projector, it is found that the approach that assumes that the direct alignment

$$Π {z}_{T}^{CLIP} and {z}_{I}^{{f}_{θ}}$$

works using an image-text pair is not effective. The reason for this is that (f_{θ}, h_{φ}) does not consider the trained data set. This method affects both VEA and a last layer retraining process. Since the goal of the present embodiment is to remove the bias of f_{θ} within the trained domain, it is important that the projector Π performs desirable performance within that domain. Estimating the projector Π with extensive (I, T) pairs may inundate it with redundant information, failing to precisely capture the data distribution relevant to (f_{θ}, h_{φ}).

As a result of estimating the directly aligned projector by minimizing

$${‖ {z}_{I}^{{f}_{θ}} - Π {z}_{T}^{CLIP} ‖}_{2}^{2} ,$$

the directly aligned projector has a negative effect on the VEA process for f_{θ}. Furthermore, even when VEA is performed, it is not effective for the last layer retraining. Accordingly, it is important to estimate the projector Π with the same data used for the training of (f_{θ}, h_{φ}).

In connection with the modality gap, it can be seen that, in the case where the number of pairs used to estimate the modality gap is changed, the WGA and average accuracy decrease significantly when there is no gap information. It is noteworthy that a mere 10 image-text pairs suffice to estimate the modality gap, yielding comparable performance to that of cases with a larger number of pairs.

In connection with VEA, DrML according to Non-patent Document 2 merely uses words that are already provided in the metadata. Accordingly, it cannot be seamlessly applied to general datasets, which lack appropriate texts in metadata. In addition, using only words in the metadata may be insufficient due to their limited quantity or misalignment with the embedding spaces, which can lead to poor debiasing performance. VEA has a positive impact also on the text data of DrML, improving both the test WGA and the average accuracy. Furthermore, it is clearly observed that TLDR's text generation scheme with VEA is significantly superior to that of DrML. That is, the VEA process is essential as relying solely on all the generated words proves to be less effective.

The word generation and the VEA process according to the present embodiment enable text-based layer retraining in situations where appropriate words are not given in the metadata of a dataset. The gain of VEA becomes larger when early stopping is not applied, which may be practical in situations where the proportion of minority groups is too low to allow appropriate early stopping. TLDR according to the present embodiment may be utilized in various industrial fields.

First, TLDR may be applied to medical image analysis and diagnosis support systems in the medical AI field. For example, TLDR may improve the accuracy of diagnosis by removing bias in a system that diagnoses diseases by analyzing medical images such as X-ray, MRI, and CT images. In addition, TLDR may support more fair and reliable diagnosis by minimizing bias in medical data.

Next, TLDR may play a significant role in the autonomous driving field. TLDR helps to accurately classify and recognize road conditions, pedestrians, vehicles, etc. recognized by the camera of an autonomous vehicle. TLDR contributes to improving the safety of autonomous vehicles by preventing misjudgments attributable to biased data. In autonomous driving technology, debiasing is essential because bias may lead to traffic accidents.

In addition, TLDR may play a significant role in security and surveillance systems. TLDR may improve fairness by removing bias such as race, gender, and the like in facial recognition systems at airports, stations, large event venues, etc. Furthermore, TLDR may improve the reliability of security by providing accurate surveillance data without bias in crime prevention and investigation.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The method of retraining the last layer of a learning model according to an embodiment described through the present specification may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method of retraining the last layer of a learning model according to an embodiment described through the present specification may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method of retraining the last layer of a learning model according to an embodiment described through the present specification may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A method of retraining a last layer of a learning model, the method being performed by an apparatus for retraining a last layer of a learning model, the method comprising:
training a last layer of a first learning model by inputting training text to a second learning model based on a projector that connects a first embedding space of the first learning model and a second embedding space of the second learning model.

2. The method of claim 1, further comprising:
before training the last layer of the first learning model,
generating the projector that connect the first embedding space of the first learning model configured to process images and the second embedding space of the second learning model configured to process an image-text set; and
selecting the training text based on the first embedding space of the first learning model and the second embedding space of the second learning model.

3. The method of claim 2, wherein:
the first learning model includes the last layer that classifies the image based on the first embedding space where features extracted by a feature extractor from the image are mapped; and
the second learning model predicts results based on the second embedding space where features extracted by an image encoder from an image of the image-text set and features extracted by a text encoder from text of the image-text set are mapped.

4. The method of claim 3, wherein generating the projector comprises:
training the projector, projecting an embedding vector of the second embedding space, to which the features extracted by the image encoder of the second learning model are mapped, onto an embedding vector of the first embedding space, to which the features extracted by the feature extractor of the first learning model are mapped, by using data used for training the first learning model.

5. The method of claim 4, wherein:
training the projector comprises training the projector by considering orthogonality between a weight of the projector and a modality gap of the second embedding space; and
the modality gap represents a state of alignment between an embedding vector corresponding to an image of the image-text set and an embedding vector corresponding to text of the image-text set in the second embedding space.

6. The method of claim 5, wherein training the projector comprises:
training the projector so that the modality gap satisfies a condition in which the modality gap lies in a nullspace of a transpose matrix of the weight of the projector.

7. The method of claim 2, wherein selecting the training text comprises:
generating first training text regarding label of classes and second training text regarding spurious attributes causing spurious correlations by using a language model;
primarily filtering the first training text based on the second embedding space; and
primarily filtering the second training text based on the second embedding space:

8. The method of claim 7, wherein selecting the training text comprises:
secondarily filtering the primarily filtered first learning text based on the last layer according to the first embedding space projected from the second embedding space through the projector.

9. The method of claim 8, wherein training the last layer of the first learning model comprises:
projecting an average of a plurality of embedding vectors, mapped to the second embedding space by using the secondarily filtered first learning text and the primarily filtered second learning text, onto an embedding vector of the first embedding space through the projector, and training the last layer by using the projected embedding vector.

10. An apparatus for retraining a last layer of a learning model, the apparatus comprising:
memory configured to store a first learning model and a second learning model; and
a controller configured to train a last layer of the first learning model by inputting training text to the second learning model based on a projector that connects a first embedding space of the first learning model and a second embedding space of the second learning model.

11. A non-transitory computer-readable storage medium having stored thereon a program that, when executed by a processor, causes the processor to execute the method set forth in claim 1.

12. A computer program that is executed by an apparatus for retraining a last layer of a learning model and stored in a non-transitory computer-readable storage medium to perform the method set forth in claim 1.
